(19) United States
(12) Patent Application Publication
(10) Pub. No.: US 2006/0151548 A1
(43) Pub. Date: Jul. 13, 2006

(54) Dosing apparatus used to pour a dose by tilting a container

(75) Inventors: Georges Seris, Paris (FR); Frederic Catteau, Paris (FR)

Correspondence Address: LERNER, DAVID, LITTENBERG,;KRUMHOLZ & MENTLIK, 600 SOUTH AVENUE WEST, WESTFIELD, NJ, 07090, US

(73) Assignee: PONT EMBALLAGE, FRESNES (FR)

(21) Appl. No.: 10/524,249

(22) PCT Filed: Aug. 8, 2003
(86) PCT No.: PCT/FR03/02493

§ 371 Date: Sep. 7, 2005

(30) Foreign Application Priority Data
Aug. 9, 2002 (FR) 02/10155
Sep. 9, 2002 (FR) 02/11122

(51) Int. Cl. G01F 11/26

(52) U.S. Cl. 222/455

(57) ABSTRACT

The present invention is an apparatus and method for pouring a specific, predetermined amount of a substance from a container without having to measure the substance. The substance is preferably a liquid or a powder. The apparatus comprises a container, a buffer chamber connected to the container, a dosage chamber connected to the buffer chamber, and an opening. When a user tilts the container up, the substance flows from the container to the buffer chamber through an opening. When the container is placed back down, a predetermined amount of the substance flows into the dosage chamber. When the container is tilted once again, the predetermined amount of the substance contained in the dosage chamber flows out through the opening.

### CROSS REFERENCE TO RELATED APPLICATIONS

This application is a National Phase Entry under § 371 of International Application No. PCT/FR2003/002493 which in turn claims the benefit of French Applications 02/10155 filed Aug. 9, 2002 and 02/11122 filed on Sep. 9, 2002.

### BACKGROUND OF THE INVENTION

The present invention relates to dosing apparatuses for releasing a specific dose of the contents of a container.

More precisely, it relates to dosing apparatuses for releasing a precise dose of contents by tilting a container.

U.S. Pat. No. 2,184,253; U.S. Pat. No. 4,151,934; and U.S. Pat. No. 5,029,736 disclose dosing containers for releasing a dose by tilting a container. A diagrammatic representation of such dosing containers is given in FIGS. 1, 2, and 3.

The dosing apparatus of FIG. 1, corresponding to the dosing apparatus disclosed in document the '253 patent, comprises two compartments 24 and 26. When the container is upturned in a vertical position, the wall bearing the reference numeral 16 toward the bottom, the first compartment 26 receives the liquid released from a main chamber of the container containing the liquid via an orifice 28. The dose accumulates in the compartment 26 until it largely passes the orifice 28. Release of the dose stops when pressures equilibrate between the gas of the compartments 26 and 24, both because the gas bubbles can no longer rise in the container and owing to compression of the gas in the compartments 24 and 26 by the liquid entering the dosing apparatus. The dosing apparatus is then returned to the vertical position, but the wall 16 this time is toward the top. The dose then passes into the compartment 24. The release of the dose then takes place by means of tilting of the container, as shown in FIG. 1, until the dosing apparatus is completely upturned, which allows the formation of another dose.

A dosing apparatus of this kind nevertheless has the drawback of not allowing a satisfactorily precise dose.

The dosing apparatus of FIG. 2, corresponding to the dosing apparatus disclosed in document the '736 patent, is a powder dosing apparatus with two compartments (c) and (d), which are filled and emptied alternately by turning upside down and the right way up, as in the '253 patent, discussed above. Filling of the compartment (c) is achieved by closing off the orifice (b) and halting the rise of the powder by means of a surface (10) inclined at the same angle as the angle of slope of the powder.

A dosing apparatus of this type does not allow satisfactory precision either. In particular, it does not offer the precision of an entirely filled compartment.

The dosing apparatus of FIG. 3, corresponding to the dosing apparatus disclosed in the '934 patent, is a dosing apparatus with two compartments 200A and 200B functioning, in accordance with the customary principle, by means of the alternate upturning and setting-upright of the container, with alternate emptying and filling of the compartments. The two compartments 200A and 200B are not in communication with one another via a space that is closed but in the open air. Filling of the compartment where the dose accumulates is achieved via a conduit 203 having a diameter of approximately one fifth of the diameter of the dosing apparatus. The compartment 200B is filled with the liquid of the container via the conduit 203, the gas from the atmosphere bubbles into the container thereby, when the level of the dose reaches the level of the orifice of the conduit filling is terminated, and it is possible to set the container and the dosing apparatus fixed to it upright.

A dosing apparatus of this type allows correct dose precision provided turning of the container takes place smoothly and rapidly.

### SUMMARY OF THE INVENTION

An object of the invention is to provide a dosing apparatus in, or removable from, a container or a package allowing doses that are more precise than those provided by the dosing apparatuses of prior-art containers.

In particular, the dosing apparatus proposed by the invention allows good dose precision. Its structure is such that handling of the container has little effect on dosage precision.

A further object of the invention is to provide a dosing apparatus that allows fluids of any viscosity, but also granules or powders, to be dosed and released.

One of the further objects of the invention is to propose a dosing apparatus allowing complete emptying of the product contained in the main container.

One of the objects of the invention is to allow doses of any volume, ranging from small volumes to more significant volumes. The volume of the dose is not influenced by the volume of the main container or by the capacity of the container.

One of the other objects of the invention is to propose a dosing apparatus that has better control of filling of the dose and its stability, irrespective of the level of contents in the main container.

One of the other objects of the invention is to propose a dosing apparatus that allows better transfer of the dose into the various parts of the dosing apparatus, irrespective of the tilt of the container.

To this end, the invention employs the principle of anti-siphoning upon creation of a dose on containers or packages.

More particularly, the invention proposes a dosing apparatus including a buffer chamber in communication in its upper part with a main chamber of a fluid or powder container and a dosing chamber that communicates with said buffer chamber via a passage in the lower part of said buffer chamber wherein the downward tilt of the container makes it possible to fill the buffer chamber and the setting-upright of the container makes it possible to cause the fluid or the powder that has entered the buffer chamber to flow into the dosing chamber, characterized in that the passage between the buffer chamber and the dosing chamber is a constricted channel forming an anti-siphon and promoting the formation of a bubble or of a puffing phenomenon in order to limit release of the fluid or of the powder when the container is set upright.

Thus, the dose to be subsequently released is formed while a dose previously formed in a chamber is released.

A constricted channel of this type allows, by means of surface tension, the formation of a stable bubble (in the case of a container filled with liquid), which limits the flow and allows particularly precise dosing. In the case of a powder, this constricted channel allows a limitation of the passage through the effect of puffing and thus makes it possible precisely to define the volume of the dose formed in the buffer chamber.

### BRIEF DESCRIPTION OF THE DRAWINGS

FIGS. 1-3 are views of prior art containers.

FIG. 4 is a sectional view of a dosing apparatus attached to a container according to the present invention, the tilt of the container allowing the formation of the dose which will be subsequently released.

FIG. 5 is a sectional view of the container depicted in FIG. 4 in the vertical rest position, the dose being formed in a chamber with a view to its being poured when the container is next tilted.

FIG. 6 is a sectional diagram of an aternate embodiment of a removable dosing apparatus attached to a container according to the present invention.

FIG. 7 is a longitudinal sectional diagram of a second possible alternate embodiment of a removable dosing apparatus on a container according to the present invention.

FIG. 8 is a perspective view of an illustrative embodiment of a container comprising an integral dosing apparatus in accordance with the invention.

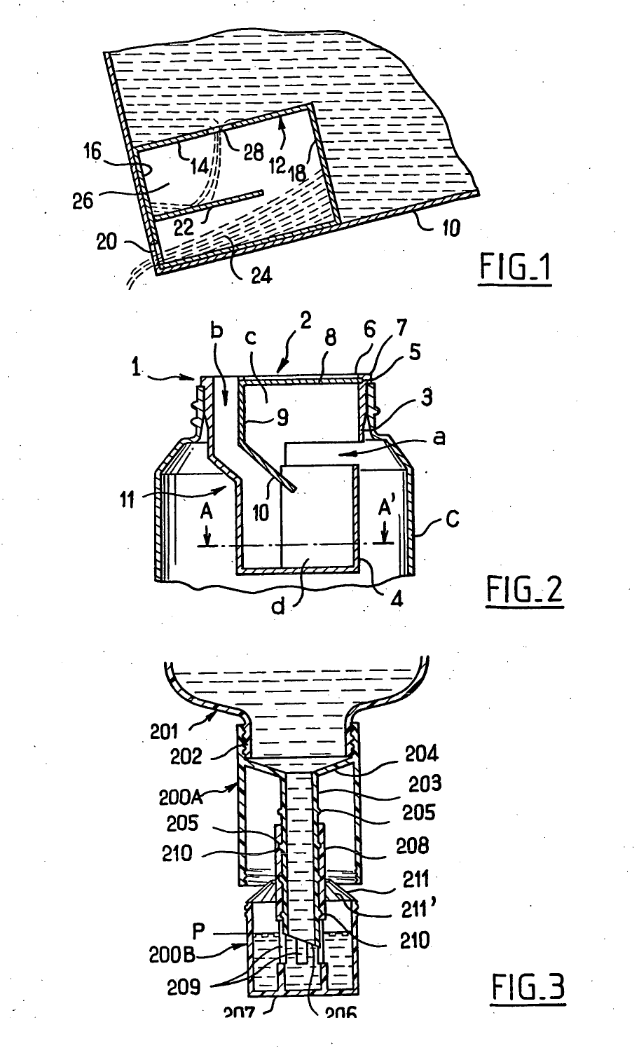

### DETAILED DESCRIPTION

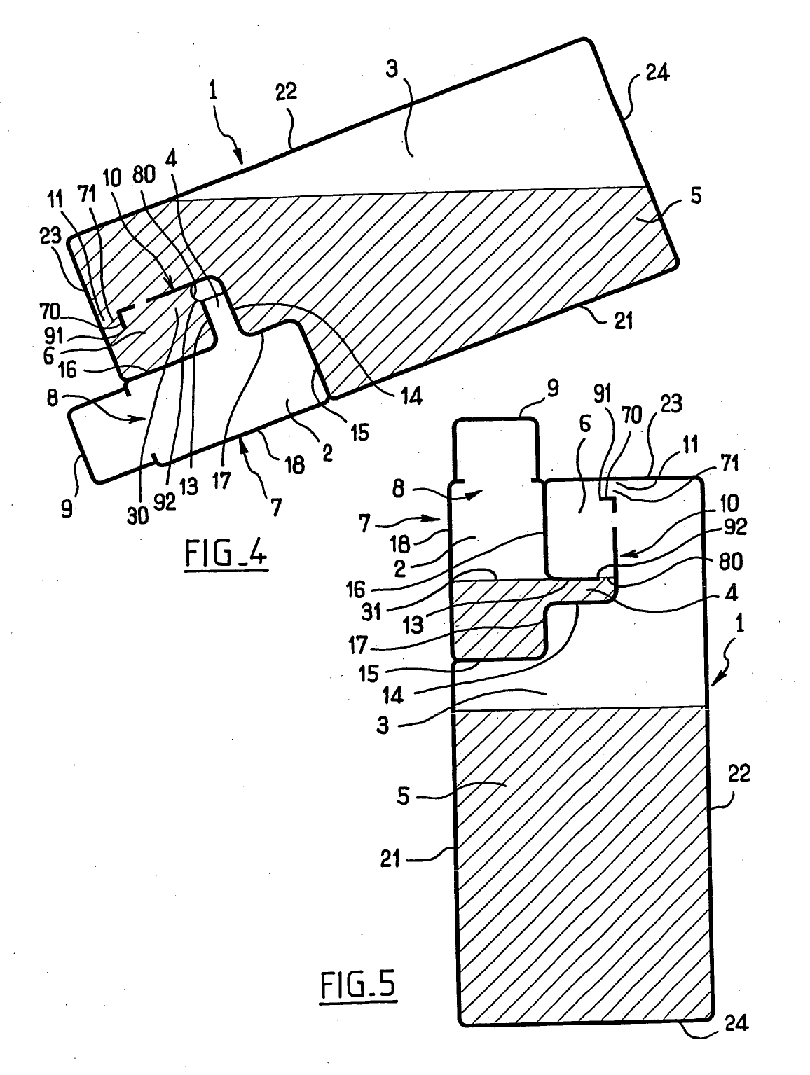

FIGS. 4 and 5 diagrammatically represent, in longitudinal section, a possible embodiment of a dosing apparatus 7 included in a container 1.

The container 1 includes lateral walls 21, 22 and upper 23 and lower 24 walls defining a main chamber 3.

It is pointed out that, in the following description, the notions of “upper” and “lower”, and also “vertical” and “horizontal”, refer to the normal position of rest of the container 1.

The container 1 preferably consists of materials of the plastics type. Preferably, the container is substantially transparent.

Preferably, the container is manufactured by means of a method including steps of extrusion and of blow molding or injection molding.

The main chamber 3 is suitable for containing a content 5. The content 5 consists of a liquid of any viscosity, granules or a powder of different particle-size values.

The upper part of the container 1 includes a part forming a dosing apparatus 7.

In FIGS. 4 and 5, the dosing apparatus 7 is separated from the main chamber 3 by separating means 10 and 14. The means 10 and 14 preferably include a partition made together with a lateral wall of the container 1. In FIGS. 4 and 5, the partition 14 is made together with the wall 21 and extends substantially perpendicularly to said wall 21, toward the inside of the container 1.

The dosing apparatus 7 principally includes three parts.

A first part forms a buffer chamber 6 between the main chamber 3 of the container 1 and a second part of the dosing apparatus 7 forming chamber 2. The buffer chamber 6 makes it possible to form, precisely in terms of quantity, the dose of content 5 to be released out of the container.

The two chambers 6 and 2 are connected by a third part of the dosing apparatus 7, consisting of a constricted channel 4. The channel 4 makes it possible to cause the content 5 to pass from the buffer chamber 6 to the dosing chamber 2 via a constriction 80. This channel 4 extends transversely relative to the height direction of the container (height of the chamber 3 and of the chamber 2, which corresponds to the vertical direction when the container is placed on its base). In this way, the channel 4 forms an elbow between the buffer chamber 6 and the dosing chamber 2.

Thus, the buffer chamber 6 is connected, on the one hand, to the main chamber 3 and, on the other hand, to the dosing chamber 2 by means of the channel 4 via the constriction 80.

The dosing chamber 2 is thus connected, on the one hand, to the channel 4, itself connected to the chamber 6, and, on the other hand, to a mouth 8. The mouth 8 allows the content 5 to be released out of the dosing chamber 2.

The flow of the liquid through the opening 11, the chamber 6, the constriction 80 and the link channel 4 takes place following an S-shaped path.

Closure means (cap 9) are provided over this mouth 8.

The dosing chamber 2 is formed, in the longitudinal direction, by the space that is included between, on the one hand, the mouth 8 and, on the other hand, the partition 14. In the radial direction, the chamber 2 is included between, on the one hand, a partition 18 extending in the prolongation of the wall 21 and, on the other hand, a partition 16 forming a separation from the buffer chamber 6. The partition 16 extends substantially in one and the same plane perpendicular to the plane of FIGS. 2 and 3 and to the planes of the walls 23 and 24.

Thus, the partition 16 is made together with the upper wall 23 of the container. The partition 16 extends perpendicularly to the wall 23 toward the inside of the container 1. It will thus be understood that the partition 16 extends toward the lower part of the container 1.

The partition 16 forms an elbow toward the inside of the container 1 in order to form the partition 13. The partitions 13 and 14 together form the channel 4.

In FIGS. 4 and 5, the link channel 4 extends substantially perpendicularly to the chamber 2. However, the channel 4 may extend in other directions. It may, for example, have a curved extension. The important thing is the position of the ends of the channel for the formation of the air bubble or of the puffing phenomenon, as will be explained in the remainder of the present description.

The partition 13, which separates the link channel 4 and the chamber 6, has a limited extent. Reference numeral 92 refers to the end of the partition 13. A passage or constriction 80 is thus defined between the end 92 of the partition 13 and the partition 10. The small size of the cross section of the constriction 80 at the end of the partition relative to the other dimensions of the chamber 6 makes it possible to avoid the risks of siphoning, as will be explained in the remainder of the present description.

On the other hand, the partition 14 forms an elbow beyond the extent of the partition 13. The elbow thus forms the partition 10 that extends toward the upper part of the container 1, substantially perpendicularly to the partition 14. The partition 10 thus forms a quasi-separation between the buffer chamber 6 and the main chamber 3.

An opening 11 is made at the end of the partition 10, between the upper wall 23 and the partition 10. It allows the flow of the content 5 between the chamber 3 and the chamber 6. The fact that the opening 11 is located in the top part of the buffer chamber 6 allows better control of filling of the dose and also complete emptying of the container.

FIGS. 4 and 5 show a preferred embodiment of the dosing apparatus.

According to this variant embodiment, the partition 10 includes, at the level of the opening 11, an elbow extended by a partition 70 formed together with the partition 10 and extending toward the buffer chamber 6. The entry partition 70 extends, for example, toward the inside of the buffer chamber 6 over a distance larger than the cross section of the communication passage 80. The end of the partition 70 inside the chamber 6 bears the reference numeral 91 in FIGS. 4 and 5. The partition 70 extends preferably substantially parallel to the wall 23 and to the partition 13. It thus defines a passage 71 between the main chamber 3 and the buffer chamber 6 in the top parts of said chambers. The passage 71 allows better control of the formation of the dose. However, it is possible to make provision for embodiments that have neither partition 70 nor passage 71.

The vent 12 formed in the partition 10 allows evacuation of the air bubble after formation of the dose, as will be explained in the remainder of the present description. It remains optional.

A description will now be given of how the container according to the invention functions.

In a first stage, the container includes a certain level of content 5 in the chamber 3. In an initial situation, the chambers 6 and 2 are considered to be completely empty.

With reference to FIG. 4, the user, wishing to release a certain dose of content out of the container, tilts the container 1.

When this tilting takes place, the content 5 is released from the chamber 3 and via the opening 11 and/or the passage 71 into the chamber 6.

The chamber 6 fills up until the content 5 reaches the constriction 80 at the end 92 of the partition 13 in FIG. 4. At this point, an air bubble forms in the channel 4 in the case of a liquid content, or a puffing phenomenon of the flow arises in the case of a powder or of granules. The air bubble or puffing phenomenon prevents the initiation of a siphon in the channel 4 and the release of all the content 5 into the chamber 2 via the channel 4. For this reason, the constriction 80 has to be of a relatively small size compared to the other dimensions of the chamber 6 in order to prevent any initiation of a siphon and any overdosing. This constriction 80 is such that, by means of capillary tension, it allows the formation of a stable bubble that limits the flow and constitutes the innovative aspect of this highly precise dosing method. This constriction 80 also limits the passage of the powder through a puffing phenomenon and thus makes it possible precisely to define the volume of the dose formed in the buffer chamber 6.

Similarly, in the preferred embodiment of FIGS. 4 and 5, the cross section and the length of the passage 71 between the partition 70 and the upper wall 23 are calculated so as to prevent the formation of a siphon when the container is tilted.

Once this air bubble or this puffing phenomenon has been created and the content 5 can no longer pour into the chamber 6, the user rights the container once again, as indicated in FIG. 5.

It will be recalled that the constriction 80 of the channel 4 must have a small cross section in order to prevent the initiation of a siphon (anti-siphon) when the container is tilted. The constriction 80 must, however, be of sufficient cross section to allow rapid passage of the dose from the buffer chamber 6 to the dosing chamber 2. The constriction 80 must also allow the passage of air into the various parts of the dosing apparatus when necessary.

It will be understood that the vent 12 allows the evacuation of the air in the case of a liquid content when the dose is formed and allows the container 1 to be returned to its rest position. It also allows better circulation of air in the case of granules. The precision of the dose volume is thus substantially enhanced. The transfer of the dose from the chamber 6 to the chamber 2 is also accelerated. The vent 12 also makes it possible to limit volumetric dispersions of the dose, these volumetric dispersions being due to the tilting movements of the container 1. The evacuation of the air makes it possible to avoid the return of a portion of the dose toward the main chamber 3 when the container is righted once again.

The opening 11 and/or the passage 71 provide a direct entry from the main chamber into the top part of the dosing apparatus. Consequently, this makes it possible to obtain better control of filling of the dose, which takes place solely by means of the container or the package being upturned. The fact that the opening 11 or the passage 71 is directly in the vicinity of the upper wall 23 also makes it possible to guarantee complete emptying of the product contained in the container. The dose will never have a volume greater than that required, even allowing for tolerance. Tolerance in respect of the volume of the doses is of the order of ±10%.

Thus, the quantity of content that will be released each time the container is manipulated is determined by the volume of the chamber 6.

The volume of the chamber 6 is, in particular, determined by the size of the container 1 in a direction perpendicular to the plane of FIGS. 4 and 5. It will also be understood that the cross section of the constriction 80 and the dimensions of the partition 70 and of the passage 71 are important.

Depending on the dosing apparatus, the quantity is varied in each dose by varying these different parameters. For a given dosing apparatus, the volume of the dose will be constant from one dose to the next.

The main container may have any capacity and any dose capacity is possible.

As a function of the desired uses, it is thus possible, typically, to obtain variable doses ranging, for example, from 5 to 60 cm³ for a container 1 with a capacity of one liter and over. These doses correspond, for example, to uses for products for domestic purposes.

It is also possible to obtain doses of 1 or 2 ml for pharmaceutical, veterinary or phytosanitary applications, for example.

When the user wishes to pour the dose, he then removes the closure means 9 from the mouth 8, leans the container 1 over and releases the dose contained in the chamber 2.

During release of the dose, the process indicated in FIG. 4 recommences, the chamber 6 refills and a new air bubble is formed at the level of the constriction 80. A new dose is created in the chamber 6. This dose will be released into the chamber 2 when the container has been righted once again.

This gives rise to the release of a dose simultaneously with preparation of the next dose to be released.

The dose in the chamber 6 may be created with or without the presence of the closure means 9 over the mouth 8 of the dosing apparatus 7.

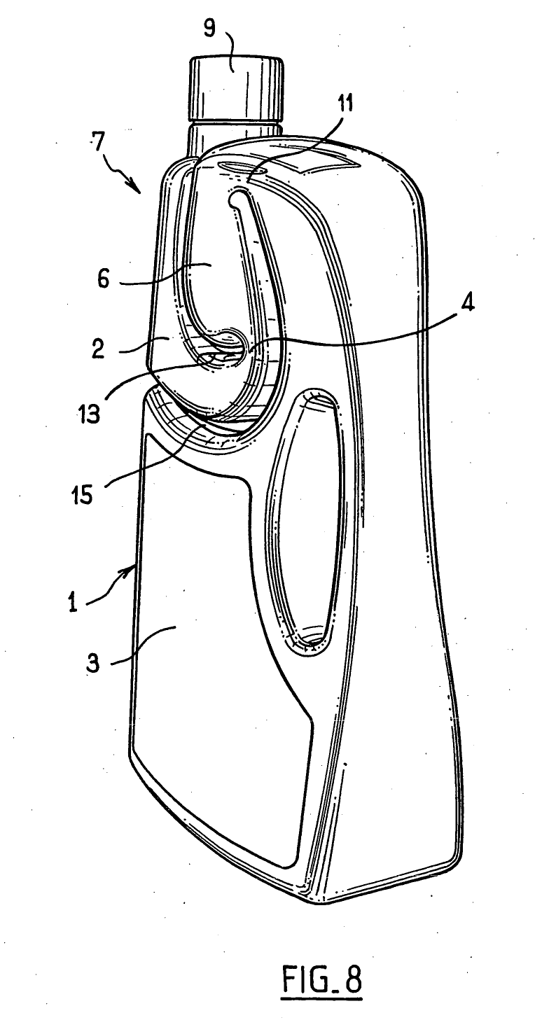

FIG. 8 represents an illustrative embodiment of a container comprising an integral dosing apparatus. This figure shows a main chamber 3 and a dosing apparatus comprising a buffer chamber 6 and a dosing chamber 2. The main chamber 3 containing a content that it is desired to dose is connected to the buffer chamber 6 via a passage 11. The buffer chamber 6 and the dosing chamber are connected by a channel 4.

The above developments apply preferably to a container 1 of which the dosing apparatus 7 is integral with the main chamber 3.

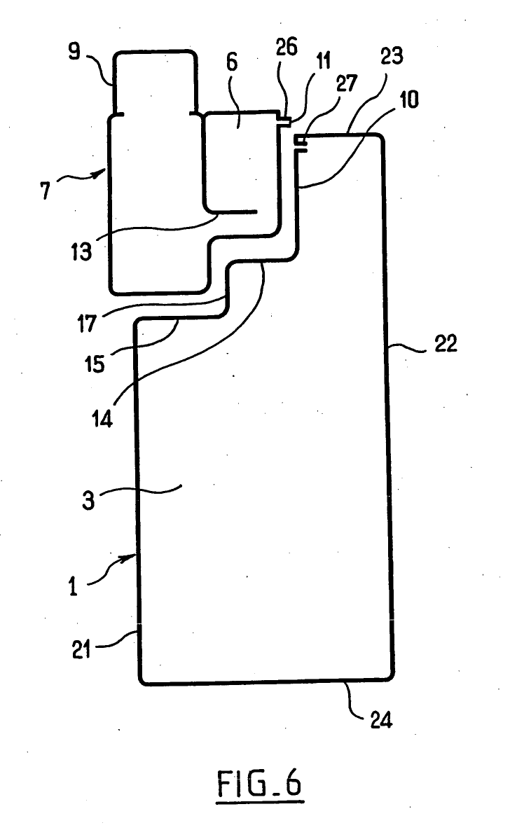

FIG. 6 diagrammatically represents a possible embodiment in which a part of the dosing apparatus 7 can be removed from the container 1. In this figure, the container includes substantially the same elements as the containers of FIGS. 4 and 5. Common elements bear similar reference numerals.

FIG. 6 shows a variant embodiment of a removable dosing apparatus 7 on the main body of the container 1.

According to this variant embodiment, the main body of the container includes only the main chamber 3, the container 1 thus being delimited by the walls 23, 22, 24, 21, 14, and 10. It will also be noted that the walls 15 and 17 extend the partition 14 between the channel 4 and the wall 21. The partitions 15 and 17 are perpendicular to one another. This shows that the partition 14 does not have to extend straight. The partitions 15 and 17 thus form an indentation that makes it possible to facilitate fixing of the dosing apparatus 7 onto the container 1.

The buffer chamber 6 is included in the removable dosing apparatus 7. Extension means 26 are complementary reception means 27 that form the mouth of the passage 11.

A number of variant embodiments are possible for closing off the mouth of the passage 11.

The complementary wall of the wall 10 on the container 1 may completely close off the end of the passage 11. In this case, the fixed wall is pierced by extension means 26. Once the wall has been pierced, closing-off means are then provided to prevent the leakage of the content 5 when the dosing apparatus 7 is separated from the main part of the container 1.

The end of the passage may already be pierced. Provision is then made for means forming a removable inner capsule in order to close off the end. The inner capsule may be formed by adhesive means, for example. Provision may also be made for means forming removable stoppers.

In all cases, the means 26 on the one hand and 27 on the other hand interact so as to guarantee a degree of join leaktightness between the different chambers.

The dosing apparatus 7 is removable and may be moved from a principal part of a container 1 to another.

Preferably, means for holding the removable dosing apparatus 7 on the main body are provided. These means may include adhesive systems between the dosing apparatus 7 and the body 1, or means forming hooks, complementing recesses, for example. The holding means make it possible to secure the two parts together. The hooks are made together with the outer faces of the dosing apparatus 7 or the main part of the container 1, for example. The dosing apparatus 7 is thus removable by means of snap-fitting onto the main part of the container 1.

Of course, other variant embodiments of removable dosing apparatus are possible.

Preferably, the dosing apparatus includes the buffer chamber, the dosing chamber, the channel and the flow opening. It is positioned on a container that does not necessarily have the shape nor the means adapted as in the variant embodiment of FIG. 6.

The dosing apparatus may thus include, on one of its lateral or lower walls, means for fixing on a mouth of a conventional, prior-art container.

The fixing means are preferably made together with the lateral or lower walls of the dosing apparatus. They include, for example, means for fixing by snap-fitting onto the main container or complementary means of tongue/groove type.

Once the dosing apparatus 7 has been fixed onto the mouth of the container, the arrangement of the dosing apparatus relative to the main chamber of the container is the same as in FIGS. 4 to 6.

It is, however, necessary to adapt the shape of the lateral walls of the dosing apparatus so that the opening for the flow of the content into the buffer chamber is in communication with the main chamber of the container, so that the content is able to flow from the main chamber of the container toward the buffer chamber and the dosing chamber.

It will therefore be understood that a plurality of forms of the walls of the dosing apparatus are possible, depending on the container onto which it has to be fitted.

In particular, it is possible to create a supplementary channel made together with the lateral walls of the dosing apparatus and penetrating the mouth of the container, so as to provide communication between the flow opening and the main chamber of the container on which the dosing apparatus is to be positioned.

According to yet a further variant embodiment, the supplementary channel also forms the means for fixing the dosing apparatus onto the container.

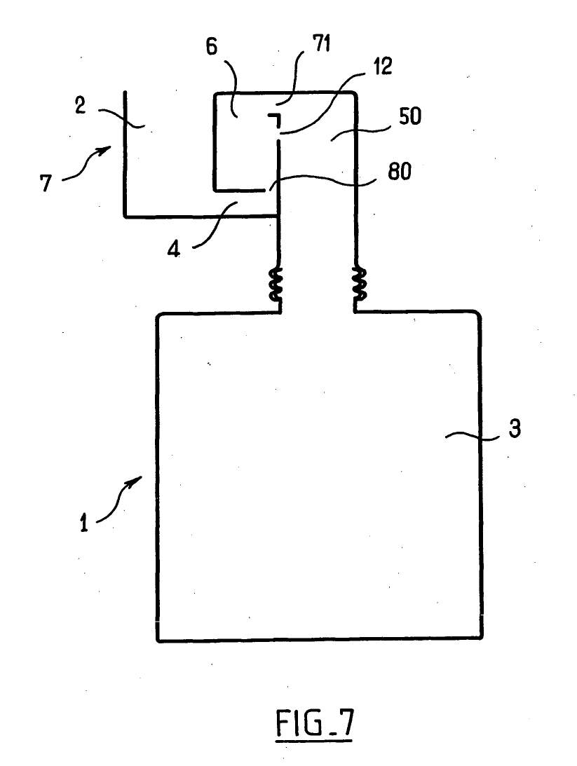

Thus, as shown in FIG. 7, a supplementary channel 50 made together with the walls 10 and 23 of the dosing apparatus is formed. Furthermore, as shown in FIG. 7, all the elements of the dosing apparatus 7 are identical to the preceding description. Similar elements bear the same reference numerals. The channel 50 makes it possible to fit the dosing apparatus onto any kind of container whatsoever by fitting, for example by means of screwing, onto the mouth of any container. It will be seen, by virtue of FIG. 7, that no adaptation of the walls of the container is necessary.

It will thus be understood that the elements forming the dosing apparatus may be adapted to any prior-art form of container and container mouth whatsoever.

The dosing apparatuses thus formed can be removed from the containers.

All the embodiments shown in the figures and described in the present description may be produced by means of extrusion blow molding in a single operation, which makes it possible to obtain a low cost price because there is no assembly of pieces.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1-13. (canceled)

14. A dosing apparatus, comprising:
(a) a container comprising a main chamber;
(b) a buffer chamber in communication with the main chamber; and
(c) a dosing chamber in communication with the buffer chamber via a constricted channel which forms an anti-siphon in the lower part of the buffer chamber and promotes the formation of a bubble or of a puffing phenomenon;
whereby the downward tilt of the container at least partially fills the buffer chamber, and the setting upright of the container causes a substance that has entered the buffer chamber to flow into the dosing chamber.

15. The dosing apparatus of claim 14, wherein the substance is a liquid.

16. The dosing apparatus of claim 14, wherein the substance is a powder.

17. The dosing apparatus as claimed in claim 14, wherein the main chamber of the container and the buffer chamber are separated by a partition that ends, at the entry for communication between these two chambers, in a return substantially parallel to an upper wall of the buffer chamber of the dosing apparatus.

18. The dosing apparatus as claimed in claim 14, wherein the main chamber of the container and the buffer chamber are separated by a partition that ends, at the entry for communication between these two chambers, in a return substantially parallel to the general direction of a channel between the buffer and dosing chambers.

19. The dosing apparatus of claim 14, further comprising a vent between the main chamber and the buffer chamber which opens into the buffer chamber above a channel that connects the buffer chamber to the dosing chamber and below an entry via which the fluid or the powder is released into said buffer chamber.

20. The dosing apparatus of claim 14, wherein the constricted channel forms an elbow toward the dosing chamber.

21. The dosing apparatus of claim 14 wherein the flow of a liquid or powder from the main chamber through the buffer chamber and out the constricted channel follows an S-shaped path.

22. The dosing apparatus of claim 14 wherein the buffer chamber and the dosing chamber may be removed from the container.

23. The dosing apparatus of claim 22, wherein the buffer chamber is connected to the container using threads that match up to the threads on the container.

24. The dosing apparatus of claim 23 further comprising a supplemental channel which connects the buffer chamber to the main chamber.

25. The dosing apparatus as claimed in claim 22, wherein the buffer chamber is connected to the container with a supplemental chamber that includes means for fixing onto the container.

26. A dosing apparatus as claimed in claim 14 wherein the container is a bottle.

27. A method of measuring doses of a substance from a dosing apparatus, the method comprising:
(a) tilting the dosing apparatus from an original position to a tilted position so that the substance contained in a container attached to the dosing apparatus enters a buffer chamber in the dosing apparatus;
(b) returning the dosing apparatus to the original position so that a predetermined amount the substance flows from the buffer chamber to a dosing chamber in the dosing apparatus and the remaining amount of the substance returns to the container; and
(c) tilting the dosing apparatus again to expel the predetermined amount of the substance from the dosing chamber.

28. The method of claim 25 wherein the substance is a liquid.

29. The method of claim 26 wherein the substance is a powder.

30. The method of claim 26 wherein the container is a bottle.

31. An apparatus for measuring predetermined amounts of a substance, the apparatus comprising:
(a) a container for storing the substance;
(b) a buffer chamber of a predetermined volume separated from the container by a wall with an opening; and
(c) a dosing chamber including an opening separated from the buffer chamber by a wall with a constricted channel.
